(19) United States
(12) Patent Application Publication
(10) Pub. No.: US 2016/0211548 A1
(43) Pub. Date: Jul. 21, 2016

(54) Gel Electrolyte and Lithium Ion Battery Employing the Gel Electrolyte

(71) Applicants: BASF CORPORATION, Florham Park, NJ (US); BASF BATERY MATERIALS (SUZHOU) CO.,LTD., Suzhou, Jiangsu (CN)

(72) Inventors: Lihua JIN, Jiangsu (CN); Xueshan HU, Jiangsu (CN); Martin PAYNE, Independence, OH (US)

(21) Appl. No.: 14/916,688

(22) PCT Filed: Sep. 12, 2013
(86) PCT No.: PCT/CN2013/083378

§ 371 Date: Mar. 4, 2016

(51) Int. Cl. H01M 10/0565; H01M 10/0525

(52) U.S. Cl. CPC H01M 10/0565; H01M 10/0525; H01M 2300/0085

(57) ABSTRACT

The invention relates to a composition for preparing a gel electrolyte characterized in that the composition comprises: (1) at least one compound of formula (1), wherein each R₁, R₂ and R₃ independently is a linear or branched alkenyl or alkynyl having 2 to 7 carbon atoms, R₄ is a alkyl having 1 to 5 carbon atoms, hydroxyl, or R₅COO—, wherein R₅ is a linear or branched alkenyl or alkynyl having 2 to 7 carbon atoms, and n is an integer of 0, 1 or 2, and the content of compound of formula (1) is 0.01-10 wt %, preferably 0.1-8 wt % based on the total weight of the composition; (2) a non-aqueous solvent, wherein the content of the nonaqueous solvent is 60-99 wt %, preferably 80-98 wt % based on the total weight of the composition; (3) a lithium salt, wherein the concentration of the lithium salt in the non-aqueous solvent is 0.2-2.0 mol/L, preferably 0.8-1.5 mol/L. The invention also relates to a gel electrolyte obtained by polymerization, especially in-situ thermal polymerization of the composition and lithium-ion battery employing the gel electrolyte.

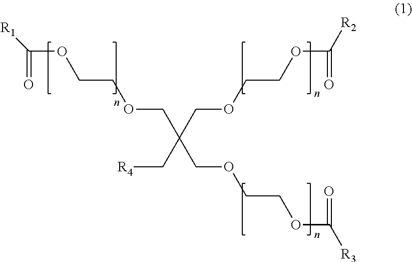

### FIELD OF THE INVENTION

The invention relates to a composition for preparing a gel electrolyte, a gel electrolyte obtained from the composition, and lithium ion battery employing the gel electrolyte.

### DESCRIPTION OF RELATED ARTS

Lithium ion battery is generally classified into liquid lithium ion battery and polymer lithium ion battery due to its different electrolyte used. It is well known that liquid lithium ion battery has high charge-discharge rate and good low-temperature performance, but its liquid electrolyte may leak and cause safety problem. Polymer lithium ion battery has higher safety performance, ionic conductivity, chemical stability, thermal stability, and interface stability with lithium electrodes, however, its initial discharge capacity and capacity retention after cycle is not satisfactory.

For example, CN 03158361.X, CN200610122573.7, and CN201010152084.2 disclosed a gel electrolyte, respectively. However, their initial capacity or capacity retention after cycle does not meet the requirement of lithium ion battery.

Thus, there is still a need to provide a gel electrolyte having higher initial capacity, discharge rate, and capacity retention after cycle.

### SUMMARY OF THE INVENTION

For the purpose of the invention, the invention provides a composition for preparing a gel electrolyte characterized in that the composition comprises:

(1) at least one compound of formula (1):

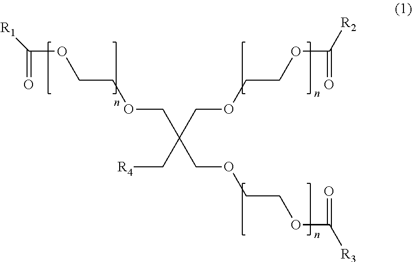

wherein each R₁, R₂ and R₃ independently is a linear or branched alkenyl or alkynyl having 2 to 7 carbon atoms, R₄ is a alkyl having 1 to 5 carbon atoms, hydroxyl, or R₅COO—, wherein R₅ is a linear or branched alkenyl or alkynyl having 2 to 7 carbon atoms, and n is an integer of 0, 1 or 2;

(2) a non-aqueous solvent; and

(3) a lithium salt.

The invention also provides a gel electrolyte obtained by polymerization, especially in-situ thermal polymerization of the composition above.

The invention further provides a gel electrolyte battery comprising:

(1) an anode,

(2) a cathode; and

(3) a gel electrolyte above.

### DESCRIPTION OF DRAWING

FIG. 1 shows a graph of capacity retention of lithium ion battery of Example 2 and comparative example at room temperature.

### EMBODIMENTS OF THE INVENTION

In one embodiment of the present invention, the invention provides a composition for preparing a gel electrolyte characterized in that the composition comprises:

(1) at least one compound of formula (1):

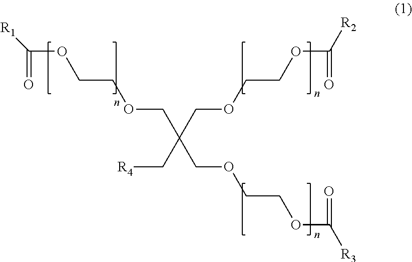

wherein each R₁, R₂ and R₃ independently is a linear or branched alkenyl or alkynyl having 2 to 7 carbon atoms, R₄ is a alkyl having 1 to 5 carbon atoms, hydroxyl, or R₅COO—, wherein R₅ is a linear or branched alkenyl or alkynyl having 2 to 7 carbon atoms, and n is an integer of 0, 1 or 2;

(2) a non-aqueous solvent; and

(3) a lithium salt.

Preferably, R₄ is an alkyl having 1 to 4 carbon atoms, such as methyl, ethyl, propyl etc.

In one preferred embodiment of the invention, the content of compound of formula (1) is 0.01-10 wt %, preferably 0.1-8 wt % based on the total weight of the composition, the content of the non-aqueous solvent is 60-99 wt %, preferably 80-98 wt % based on the total weight of the composition, and the concentration of the lithium salt in the non-aqueous solvent is 0.2-2.0 mol/L, preferably 0.8-1.5 mol/L.

In one preferred embodiment of the invention, the compound of formula (1) is selected from the group consisting of trimethylolpropane triacrylate, trimethylolpropane trimethacrylate, pentaerythritol triacrylate, pentaerythritol tetraacrylate, and ethoxylated trimethylolpropane triacrylate, and mixture thereof.

Preferably, the alkenyl or alkynyl has 2 to 5 carbon atoms. In addition, the alkenyl or alkynyl can be optionally substituted by alkyl, alkoxy, aryl, halogen, cyan, nitro, etc. The alkyl includes 1 to 20, preferably 1-10, more preferably 2-8 carbon atoms. The alkoxy includes 1 to 20, preferably 1-12, more preferably 2-8 carbon atoms. The aryl is for example phenyl, naphthyl, etc. The halogen includes fluorine, chlorine, bromine, and iodine.

In the context of the invention, the compound of formula (1) is used as a copolymerization monomer.

In one embodiment of the invention, the composition can further comprise an ethylene glycol oligomer having the structure of formula CH₂═C(R)COO(CH₂CH₂O)ₙ—COC(R)═CH₂, wherein n is an integer of 1-12, preferably 2-10, more preferably 4-8, R is methyl or ethyl, and wherein the content of the ethylene glycol oligomer is 0.1-10 wt %, preferably 0.2-8 wt %, more preferably 0.8-5 wt % based on the total weight of the composition.

In one embodiment of the invention, the composition can further comprise a silane coupling agent having the structure of formula CH₂═C(R)—COO(CH₂)ₙ—Si—(OCH₃)₃, wherein n is an integer of 1-3, R is H or methyl, and wherein the content of the silane coupling agent is 0.1-10wt %, preferably 0.2-8 wt %, more preferably 0.5-5 wt % based on the total weight of the composition.

In one embodiment of the invention, the composition can further comprise an initiator selected from the group consisting of azobisisobutyronitrile, dibenzoyl peroxide, bis(4-tert-butylcyclohexyl) peroxydicarbonate, lauroyl peroxide, and diisopropyl peroxydicarbonate, and mixture thereof, wherein the content of the initiator is 0.002-8 wt %, preferably 0.002-5 wt %, more preferably 0.002-3 wt % based on the total weight of the composition.

In one embodiment of the invention, the composition can further comprise a non-aqueous solvent selected from the group consisting of ethylene carbonate, propylene carbonate, butylene carbonate, 1,2-dimethyl ethylene carbonate, ethyl butyl carbonate, methyl butyl carbonate, dibutyl carbonate, diethyl carbonate, dimethyl carbonate, 3,3,3-trifluoropropylene carbonate, di-n-propyl carbonate, diisopropyl carbonate, methyl ethyl carbonate, ethyl propyl carbonate, ethyl isopropyl carbonate, methyl propyl carbonate, dimethoxyethane, diethoxyethane, tetrahydrofuran, 2-methyl tetrahydrofuran, diethyleneglycol dimethylether, triethylene glycol dimethylether, tetraethylene glycol dimethylether, 1,3-dioxolane, dimethyl sulfoxide, sulfolane, 4-Methyl-1,3-dioxane, γ-butyrolactone, methyl formate, ethyl formate, propyl formate, butyl formate, methyl acetate, ethyl acetate, propyl acetate, butyl acetate, vinylene carbonate, propane sultone, and ethylene sulfite, and mixture thereof, wherein the content of the non-aqueous solvent is 60-99 wt %, preferably 80-98 wt % based on the total weight of the composition.

In one embodiment of the invention, the composition can further comprise a lithium salt selected from the group consisting of lithium hexafluorophosphate (LiPF₆), lithium tetrafluoroborate (LiBF₄), lithium trifluoromethanesulfonate (LiSO₃CF₃), lithium hexafluoroarsenate (LiAsF₆), lithium bis(trifluoromethanesulfonyl)imide (LiN(CF₃SO₂)₂), lithium bis(oxalate)borate (LiBOB), and lithium tris(trifluoromethylsulfonyl)methide (LiC(CF₃SO₂)₃), and mixture thereof, wherein the concentration of the lithium salt in the non-aqueous solvent is 0.2-2.0 mol/L, preferably 0.8-1.5 mol/L.

In one embodiment of the invention, the composition can further comprise one or more additives selected from the group consisting of solid electrolyte interface forming improving agent, cathode protection agent, lithium salt stabilizer, overcharge protection agent, fire-retardant additive, Li deposition improving agent, ionic salvation enhance agent, Al corrosion inhibitor, wetting agent and viscosity diluter. Preferably, the additive is present in the amount of 0.1-10 wt % based on the total weight of the composition.

In one preferred embodiment of the invention, the composition can further comprises one or more additive of the compounds of formulae (2) to (14) in the amount of 0.1-10 wt % based on the total weight of the composition,

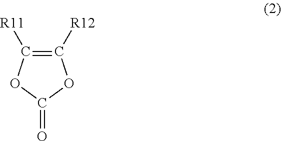

wherein R11 and R12 are each independently a hydrogen group, a halogen group, an alkyl group, or an halogenated alkyl group,

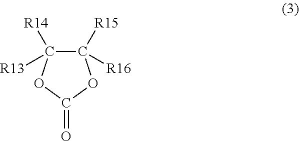

wherein R13 to R16 are each independently a hydrogen group, a halogen group, an alkyl group, a halogenated alkyl group, a vinyl group, or an allyl group, where at least one of R13 to R16 is a vinyl group or an allyl group,

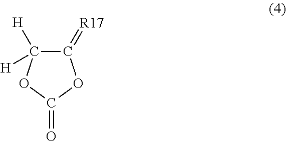

wherein R17 is an alkylene group,

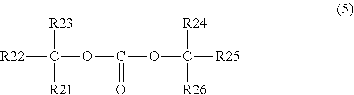

wherein R21 to R26 are each independently a hydrogen group, a halogen group, an alkyl group, or a halogenated alkyl group, where at least one of R21 to R26 is a halogen group or a halogenated alkyl group,

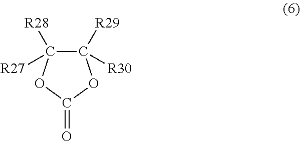

wherein R27 to R30 are each independently a hydrogen group, a halogen group, an alkyl group, or a halogenated alkyl group, where at least one of R27 to R30 is a halogen group, or a halogenated alkyl group,

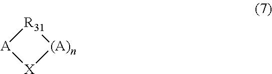

wherein R₃₁ is an optionally substituted alkylene group of 1 to 6 carbon atoms, an optionally substituted alkenylene group of 2 to 6 carbon atoms, or an optionally substituted bridge ring, A represents C═O, SO, or SO₂, n is 0 or 1, and X represents oxygen (O) or sulfur (S),

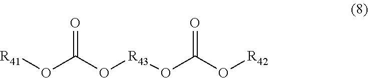

wherein R₄₁ and R₄₂ are each independently an optionally substituted alkyl group of 1 to 6 carbon atoms, an optionally substituted alkenyl group of 2 to 6 carbon atoms, or an optionally substituted alkynyl group of 2 to 6 carbon atoms, and R₄₃ represents an optionally substituted alkylene group of 1 to 6 carbon atoms, an optionally substituted alkenylene group of 2 to 6 carbon atoms, an optionally substituted alkynylene group of 2 to 6 carbon atoms, or an optionally substituted bridge ring, where the substituent represents a halogen atom or an alkyl group,

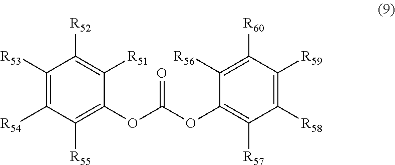

wherein R₅₁ to R₆₀ represent an optionally substituted alkyl group of 1 to 18 carbon atoms, an alkenyl group, an alkynyl group, an alkoxy group, or an alkylamino group, which may be connected to each other to form a ring, where the substituent represents a halogen atom or an alkyl group,

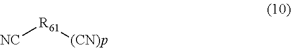

wherein R₆₁ represents an optionally substituted alkylene group of 1 to 36 carbon atoms, an optionally substituted alkenylene group of 2 to 36 carbon atoms, an optionally substituted alkynylene group of 2 to 36 carbon atoms, or an optionally substituted bridge ring, p is an integer of 0 or more with an upper limit determined by R₆₁,

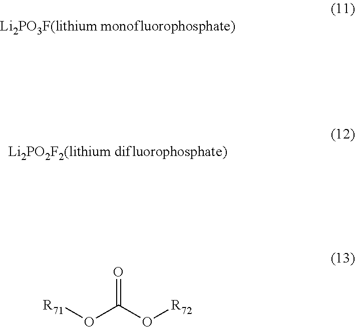

wherein R₇₁ and R₇₂ are each independently an alkyl group or a halogenated alkyl group,

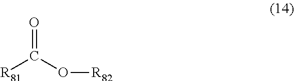

wherein R₈₁ and R₈₂ each independently represent a chain alkyl group. Preferably, the additive is a compound of formula (2).

Preferably, the additive is one or more selected from the group consisting of vinylene carbonate, ethylene carbonate, monofluoro ethylene carbonate, vinyl ethylene carbonate, fluoroethylene carbonate, ethylene sulfite, 1,3-propane sultone, N,N-diethylamino trimethylsilane, tris(2,2,2-trifluoroethyl)phosphite, 1-methyl-2-pyrrolidinone, fluorinated carbamate, hexamethyl-phosphoramide, cyclohexyl benzene, biphenyl, hexamethoxycyclotriphosphazene, 2-methyltetrahydrofuran, tris(pentafluorophenyl)borane, trialkyl phosphate, ethylene sulfate, propylene sulfite, trimethylene sulfite, phenylacetone, 1,4-butane sultone, propane 1,2-cyclic suefate, propane 1,2-cyclic sulfite, diethyl(cyanomethyl)phosphate, N,N-dimethylformamide, methylene methanedisulfonate, tris(trimethylsilyl)phosphite, tris(trimethylsilyl)phosphate, tris(trimethylsilyl)borate, 1,3-butylene glycol sulfite, N,N′ -dimethyl-trifluoroacetamide, 2,2-diphenyl propane, N,N′-dicyclohexyl carbodiimide, chloroethyleneglycol carbonate and 1,3-dioxolane,4,5-dichloro-2-oxo. More preferably, the content of the additives is 0.1-10wt % based on the total weight of the composition.

According to the invention, the gel electrolyte is obtained by polymerization, especially in-situ polymerization of the composition above. In the context of the present invention, the in-situ polymerization means that the polymerization is carried out in a lithium ion battery to be formed. Herein the traditional liquid electrolyte consists of organic solvents, lithium salts and optionally additives.

Preferably, the polymerization, especially in-situ polymerization is performed at the temperature of 20 to 100° C. , more preferably 60 to 85° C. for 4-48 hours.

In one embodiment of the present invention, the invention provides a gel electrolyte battery comprising:

(1) an anode,

(2) a cathode; and

(3) the gel electrolyte prepared above.

In one embodiment of the present invention, the gel electrolyte battery further comprises separator.

Examples of anode active materials can be: natural graphite, artificial graphite, modified graphite, amorphous graphite, mesocarbon microbeads, Si-based materials, Sn-based materials, and Li₄Ti₅O₁₂, or a combination thereof. Examples of cathode active material can be: LiCoO₂, LiNiO₂, LiNi_{1-(x+y)}CoₓM_{y}O₂ (M represents Mn or Al, 0≦x≦1, 0≦y≦1, 0≦x+y≦1), LiFePO₄, LiVPO₄, LiMnPO₄, LiFe_{1-a-b}VₐMn_{b}PO₄(0≦a≦1, 0≦b≦1, 0≦a+b≦1), Li₂FeSiO₄, Li₂MnSiO₄, and Li₂Fe_{z}Mn_{1-z}SiO₄(0<z<1), or a combination thereof.

In the present invention, all shapes of lithium ion battery can be assembled by the electrodes, gel electrolyte and separator above, like cylindrical Li-ion battery, prismatic Li-ion battery, soft-pack Li-ion battery and so on.

This gel electrolyte can be used in lithium ion battery for EV/HEV and digital products, etc.

The initial discharge capacity, discharge rate, and capacity retention after cycle is tested by BK-6864AR/5 (5V5A) rechargeable battery Testing System (Guangzhou Blue-key Electronic Industry Co.Ltd, China).

All percentages are mentioned by weight unless otherwise indicated.

### EXAMPLES

The present invention is now further illustrated by reference to the following examples, however, the examples are used for the purpose of explanation and not intended to limit the scopes of the invention.

### COMPARATIVE EXAMPLE

The traditional liquid electrolyte solution was formulated as 1M LiPF₆ dissolved in a mixture of ethylene carbonate: ethyl methyl carbonate=3:7 (by weight), wherein the traditional liquid electrolyte solution also comprises 1 wt % of vinylene carbonate based on the weight of the traditional liquid electrolyte solution.

The traditional liquid electrolyte solution is prepared in BRAUN glove box with argon gas of 99.999% purity and water content of ≦5 ppm at room temperature, wherein ethylene carbonate and ethyl methyl carbonate are mixed, and then LiPF₆ is added slowly and dissolved sufficiently, finally vinylene carbonate is added and mixed evenly to obtain light yellow transparent liquid with water content of ≦2 ppm.

### Example 1

The electrolyte in example 1 was obtained from the composition as follows:

| | | |
|---|---|---|
| trimethylolpropane triacrylate | 0.46 | wt % |
| triethylene glycol dimethacrylate | 1.38 | wt % |
| γ-(methacryloxy) | 1.15 | wt % |
| propyltrimethoxylsilane | | |
| azobisisobutyronitrile | 0.01 | wt % |
| The traditional liquid electrolyte | 97 | wt % |
| solution of Comparative example | | |

The electrolyte of Example 1 is prepared in BRAUN glove box with argon gas of 99.999% purity and water content of ≦5 ppm at room temperature, wherein trimethylolpropane triacrylate, triethylene glycol dimethacrylate, γ-(methacryloxy) propyltrimethoxylsilane and azobisisobutyronitrile are added into the traditional liquid electrolyte solution and mixed evenly to obtain colorless transparent liquid with water content of ≦2 ppm.

### Example 2

The electrolyte in example 2 was obtained from the composition as follows:

| | | |
|---|---|---|
| trimethylolpropane triacrylate | 0.69 | wt % |
| triethylene glycol dimethacrylate | 2.06 | wt % |
| γ-(methacryloxy) | 1.73 | wt % |
| propyltrimethoxylsilane | | |
| azobisisobutyronitrile | 0.02 | wt % |
| The traditional liquid electrolyte | 95.5 | wt % |
| solution of Comparative example | | |

The electrolyte of Example 2 is prepared in BRAUN glove box with argon gas of 99.999% purity and water content of ≦5 ppm at room temperature, wherein trimethylolpropane triacrylate, triethylene glycol dimethacrylate, γ-(methacryloxy) propyltrimethoxylsilane and azobisisobutyronitrile are added into the traditional liquid electrolyte solution and mixed evenly to obtain colorless transparent liquid with water content of ≦20 ppm.

### Preparation and Performance Test of Lithium Ion Battery

The lithium cobalt oxide (LCO) soft-pack cell is dried at 80-85° C. for 48 hours and placed in glove box for use.

The electrolyte of Example 1, Example 2 and Comparative example are injected into dry cell respectively, sealed and stood for 16-24 hours. Then, the lithium cobaltate ion battery of Example 1 and Example 2 are transferred into oven to polymerize for 8-16 hours at 60° C. Finally, the resulted gel electrolyte of Example 1 and Example 2 and liquid electrolyte of Comparative example are subjected to formation and vacuum sealed and graded.

The initial performance of lithium ion battery of Example 1 and Comparative example are shown in table 1.

TABLE 1

| | Initial internal | Initial | Initial discharge |
|---|---|---|---|
| | resistance (mΩ) | thickness (mm) | capacity (mAh) |
| Comparative | 30.3 | 4.58 | 1053 |
| example | | | |
| Example 1 | 31.4 | 4.68 | 1041 |

It can been seen from table 1 that the initial internal resistance and initial thickness of the polymer gel ion battery according to the present invention is essentially equal to that of the traditional liquid ion battery, and the initial discharge capacity is comparable to that of the traditional liquid ion battery and completely meet the requirement of 1000 mAh of lithium ion battery.

### Cycle Performance Test of Lithium Ion Battery of Example 1 and Comparative Example After 300 Cycles

Cycle performance test of lithium ion battery of Example 1 and Comparative example are carried out at 25±2° C. and at relative humidity of 45-75%, and the test steps are described as follows: (a) charge to 4.2V at constant current of 1 C, and charge to cut-off current of 0.05 C at constant voltage, then stand for 10 minutes; (b) discharge to 3.0 V at constant current of 1 C and stand for 10 minutes; (c) repeat steps (a) and (b) and the cycle times are 300. The results are shown in table 2.

TABLE 2

| | | Comparative |
|---|---|---|
| | Example 1 | example |
| Capacity retention | 95% | 97% |
| after 300 cycles (%) | | |

The data in table 2 show that the capacity retention of lithium ion battery of Example 1 after 300 cycles is high and is very close to that of the traditional liquid lithium ion battery.

### Cycle Performance Test of Lithium Ion Battery of Example 2 and Comparative Example After 500 Cycles

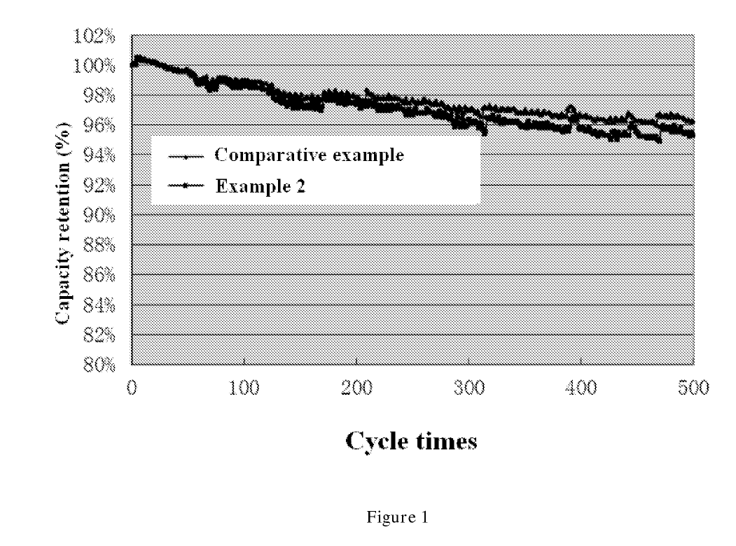

Cycle performance test of lithium ion battery of Example 2 and Comparative example are carried out at 25±2° C. and at relative humidity of 45-75%, and the test steps are described as follows: (a) charge to 4.2V at constant current of 0.7 C, and charge to cut-off current of 0.05 C at constant voltage, then stand for 10 minutes; (b) discharge to 3.0 V at constant current of 0.5 C and stand for 10 minutes; (c) repeat steps (a) and (b) and the cycle times are 500. The results are shown in table 3 and FIG. 1.

TABLE 3

| | | Comparative |
|---|---|---|
| | Example 2 | example |
| Capacity retention | 95% | 96% |
| after 500 cycles (%) | | |

The data in table 3 and FIG. 1 show that the capacity retention of lithium ion battery of Example 2 after 500 cycles is high and is very close to that of the traditional liquid lithium ion battery.

### Discharge Rate Performance of Example 1, Example 2 and Comparative Example

Discharge rate performance test of lithium ion battery of Example 1, Example 2 and Comparative example are carried out at 25±2° C. and at relative humidity of 45-75%, and the test steps are described as follows: (a) charge to 4.2V at constant current of 1 C, and charge to cut-off current of 0.05 C at constant voltage, then stand for 10 minutes; (b) discharge to 3.0 V at constant current of 0.2 C and stand for 10 minutes; (c) charge to 4.2V at constant current of 1 C, and charge to cut-off current of 0.05 C at constant voltage, then stand for 10 minutes; (d) discharge to 3.0 V at constant current of 0.5 C; (e) charge to 4.2V at constant current of 1 C, and charge to cut-off current of 0.05 C at constant voltage, then stand for 10 minutes; (f) discharge to 3.0 V at constant current of 1 C; (g) charge to 4.2V at constant current of 1 C, and charge to cut-off current of 0.05 C at constant voltage, then stand for 10 minutes; (h) discharge to 3.0 V at constant current of 2 C. The ratios of the discharge capacity in steps (b), (d), (f), (h) to the discharged electric capacity in step (b) is used as percentage in table 4. The results are shown in table 4.

TABLE 4

| Items | 0.2 C | 0.5 C | 1 C | 2 C |
|---|---|---|---|---|
| Comparative | 100% | 98% | 98% | 95% |
| example | | | | |
| Example 1 | 100% | 98% | 97% | 91% |
| Example 2 | 100% | 98% | 97% | 89% |

The data in table 4 show that the discharge rate of lithium ion battery according to the present invention is high and is comparable to that of the traditional liquid lithium ion battery.

In addition, the gel electrolytes of the present invention have no leakage during test and storage.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A composition for preparing a gel electrolyte characterized in that the composition comprises:
(1) at least one compound of formula (1): 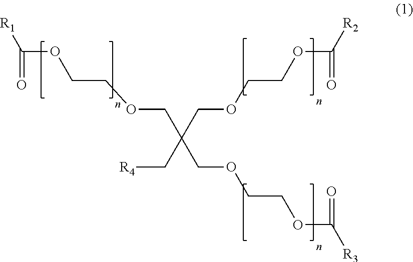
wherein each R₁, R₂ and R₃ independently is a linear or branched alkenyl or alkynyl having 2 to 7 carbon atoms, R₄ is a alkyl having 1 to 5 carbon atoms, hydroxyl, or R₅COO—, wherein R₅ is a linear or branched alkenyl or alkynyl having 2 to 7 carbon atoms, and n is an integer of 0, 1 or 2;
(2) a non-aqueous solvent; and
(3) a lithium salt.

2. The composition according to claim 1, wherein the content of compound of formula (1) is 0.01-10 wt % based on the total weight of the composition, the content of the non-aqueous solvent is 60-99 wt % based based on the total weight of the composition, and the concentration of the lithium salt in the non-aqueous solvent is 0.2-2.0 mol/L.

3. The composition according to claim 1, further comprises an ethylene glycol oligomer having the structure of formula CH₂═C(R)COO(CH₂CH₂O)ₙ—COC(R)═CH₂, wherein n is an integer of 1-12, and wherein the content of the ethylene glycol oligomer is 0.1-10 wt % based on the total weight of the composition.

4. The composition according to claim 3, wherein the content of the the ethylene glycol oligomer is 0.2-8 wt % based on the total weight of the composition.

5. The composition according to claim 1, further comprises a silane coupling agent having the structure of formula CH₂═C(R)—COO(CH₂)ₙ—Si—(OCH₃)₃, wherein n is an integer of 1-3, R is H or methyl, and wherein the content of the silane coupling agent is 0.1-10wt % based on the total weight of the composition.

6. The composition according to claim 5, wherein the content of the silane coupling agent is 0.2-8 wt % based on the total weight of the composition.

7. The composition according to claim 1, further comprises an initiator selected from the group consisting of azobisisobutyronitrile, dibenzoyl peroxide, bis(4-tert-butylcyclohexyl) peroxydicarbonate, lauroyl peroxide, and diisopropyl peroxydicarbonate, wherein the content of the initiator is 0.002-8 wt % based on the the total weight of the composition.

8. The composition according to claim 7, wherein the content of the initiator is 0.002-5 wt % based on the total weight of the composition.

9. The composition according to claim 1, wherein the non-aqueous solvent is selected from the group consisting of ethylene carbonate, propylene carbonate, butylene carbonate, 1,2-dimethyl ethylene carbonate, ethyl butyl carbonate, methyl butyl carbonate, dibutyl carbonate, diethyl carbonate, dimethyl carbonate, 3,3,3-trifluoropropylene carbonate, di-n-propyl carbonate, diisopropyl carbonate, methyl ethyl carbonate, ethyl propyl carbonate, ethyl isopropyl carbonate, methyl propyl carbonate, dimethoxyethane, diethoxyethane, tetrahydrofuran, 2-methyl tetrahydrofuran, diethyleneglycol dimethylether, triethylene glycol dimethylether, tetraethylene glycol dimethylether, 1,3-dioxolane, dimethyl sulfoxide, sulfolane, 4-methyl-1,3-dioxane, γ-butyrolactone, methyl formate, ethyl formate, propyl formate, butyl formate, methyl acetate, ethyl acetate, propyl acetate, butyl acetate, vinylene carbonate, propane sultone, and ethylene sulfite.

10. The composition according to claim 1, wherein the lithium salt is selected from the group consisting of lithium hexafluorophosphate, lithium tetrafluoroborate, lithium trifluoromethanesulfonate, lithium hexafluoroarsenate, lithium bis(trifluoromethanesulfonyl)imide, lithium bis(oxalate)borate, and lithium tris(trifluoromethylsulfonyl)methide.

11. The composition according to claim 1, further comprises one or more additive of the compounds of formulae (2) to (14) in the amount amount of 0.1-10 wt % based on the total weight of the composition, 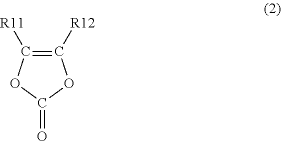
wherein R11 and R12 are each independently a hydrogen group, a halogen group, an alkyl group, or an halogenated alkyl group, 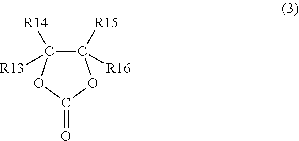
wherein R13 to R16 are each independently a hydrogen group, a halogen group, an alkyl group, a halogenated alkyl group, a vinyl group, or an allyl group, where at least one of R13 to R16 is a vinyl group or an allyl group, 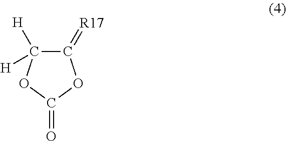
wherein R17 is an alkylene group, 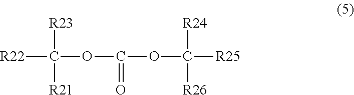
wherein R21 to R26 are each independently a hydrogen group, a halogen group, an alkyl group, or a halogenated alkyl group, where at least one of R21 to R26 is a halogen group or a halogenated alkyl group, 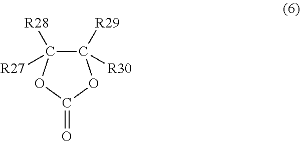
wherein R27 to R30 are each independently a hydrogen group, a halogen group, an alkyl group, or a halogenated alkyl group, where at least one of R27 to R30 is a halogen group, or a halogenated alkyl group, 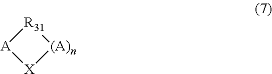
wherein R31 is an optionally substituted alkylene group of 1 to 6 carbon atoms, an optionally substituted alkenylene group of 2 to 6 carbon atoms, or an optionally substituted bridge ring, A represents C═O, SO, or SO₂, n is 0 or 1, and X represents oxygen (O) or sulfur (S), 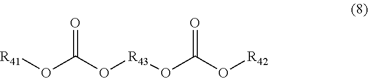
wherein R₄₁ and R₄₂ are each independently an optionally substituted alkyl group of 1 to 6 carbon atoms, an optionally substituted alkenyl group of 2 to 6 carbon atoms, or an optionally substituted alkynyl group of 2 to 6 carbon atoms, and R₄₃ represents an optionally substituted alkylene group of 1 to 6 carbon atoms, an optionally substituted alkenylene group of 2 to 6 carbon atoms, an optionally substituted alkynylene group of 2 to 6 carbon atoms, or an optionally substituted bridge ring, where the substituent represents a halogen atom or an alkyl group, 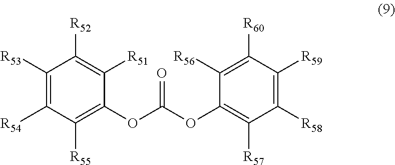
wherein R₅₁ to R₆₀ represent an optionally substituted alkyl group of 1 to 18 carbon atoms, an alkenyl group, an alkynyl group, an alkoxy group, or an alkylamino group, which may be connected to each other to form a ring, where the substituent represents a halogen atom or an alkyl group, 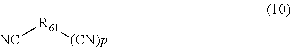
wherein R₆₁ represents an optionally substituted alkylene group of 1 to 36 carbon atoms, an optionally substituted alkenylene group of 2 to 36 carbon atoms, an optionally substituted alkynylene group of 2 to 36 carbon atoms, or an optionally substituted bridge ring, p is an integer of 0 or more with an upper limit determined by R₆₁, 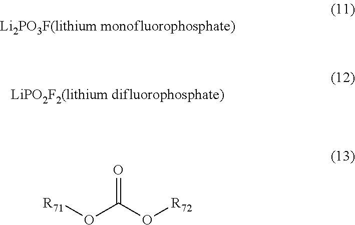
wherein R₇₁ and R₇₂ are each independently an alkyl group or a halogenated alkyl group, 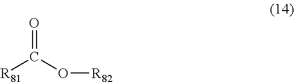
wherein R₈₁ and R₈₂ each independently represent a chain alkyl group.

12. The composition according to claim 11, wherein the additive is a compound of formula (2).

13. The composition according to claim 1, wherein the compound of formula (1) is selected from the group consisting of trimethylolpropane triacrylate, trimethylolpropane trimethacrylate, pentaerythritol triacrylate, pentaerythritol tetraacrylate, and ethoxylated trimethylolpropane triacrylate.

14. A gel electrolyte obtained by polymerization, of the composition according to claim 1.

15. A gel electrolyte battery comprising:
(1) an anode,
(2) a cathode; and
(3) a gel electrolyte according to claims 14.
